(19) United States
(12) Patent Application Publication
(10) Pub. No.: US 2003/0114956 A1
(43) Pub. Date: Jun. 19, 2003

(54) System and method for notifying sender of address change for addressee

(75) Inventors: Mark Cullen, Bethany, CT (US); Alberta A. Vitale, East Haven, CT (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 10/026,584

(22) Filed: Dec. 19, 2001

(51) Int. Cl. G06F 7/00

(52) U.S. Cl. 700/225

(57) ABSTRACT

An embodiment of the system of the present invention comprises a mailpiece sorting apparatus and a postcard printer. A list of employees that no longer work at the company or a list of changed employee addresses can be used, as well as a database of forwarding addresses. The incoming mail sorting apparatus can obtain a digital image of the front of an incoming mailpiece and can determine that the mailpiece is addressed to a former employee or an employee whose address has changed. The sender or return address is also obtained from the digital image and is printed as the recipient address on a post card. The original recipient address is printed along with a forwarding address (if available). A message is sent to the addressor that, for example, the employee is no longer at the original recipient address. The original sender is instructed to update his or her database. In another example, if a forwarding address is not known for the intended recipient, the original sender is notified that the addressee has moved and a new address is not known and a request is made for the addressee to update his or her database.

### FIELD OF THE INVENTION

The invention disclosed herein relates generally to automated mail sorting and more particularly, a method of notifying a sender of an address change for an addressee and updating an incoming mail streams.

### BACKGROUND OF THE INVENTION

The processing and handling of mailpieces consumes an enormous amount of human and financial resources, particularly if the processing of the mailpieces is done manually. The processing and handling of mailpieces not only takes place at the Postal Service, but also occurs at each and every business or other site where communication via the mail delivery system is utilized. That is, various pieces of mail generated by a plurality of departments and individuals within a company need to be addressed, collected, sorted and franked as part of the outgoing mail process. Additionally, incoming mail needs to be collected and sorted efficiently to ensure that it gets to the addressee (i.e. employee or department) in a minimal amount of time. Since much of the documentation and information being conveyed through the mail system is critical in nature relative to the success of a business, it is imperative that the processing and handling of both the incoming and outgoing mailpieces be done efficiently and reliably so as not to negatively impact the functioning of the business.

Various automated mail-handling machines have been developed for processing incoming mail (removing individual pieces of mail from a stack and performing subsequent actions on each individual piece of mail). Generally, the mail handling machines separate individual mailpieces from a stack, read the mailpieces using an optical character recognition (OCR) system and compare the read information to an addressee database in order to determine the appropriate destination points for delivery of the mailpieces. Some of the incoming mail received at a mailroom of the company can be unreadable by the OCR system, the quantity of which can be great since recipients cannot control the addressee format in which the incoming mail is received. Some of the unreadable mail could be, for example, mail which is not OCR readable called OCR rejects (i.e. smeared or needs to be opened to determine addressee), mystery mail which mail with no particular addressee (i.e. mail addressed to a company or department only or mail with poor quality handwriting), or research mail (i.e. mail that can not be read by OCR but does not require opening for the operator to determine the addressee, including the situation where there are several potential addressees with the same name). The unreadable mail, which will be referred to generally as reject mail is expensive to process since it drains the resources of the mail room requiring additional time and labor for sorting and delivery.

Another type of mail, which can be categorized as difficult to deliver, generally by incoming mail sorting apparatus is incorrectly addressed mailpieces. Such mailpieces can be outsorted to a reject bin and the addressee can be manually determined or they can be returned to sender. However, this does not solve the problem of subsequent mailpieces being sent to the same incorrect address.

An easier and possibly less costly method of handling the challenges of incorrectly addressed mail is to reduce it at it's source—where the mailing is produced. The reduction of incorrectly addressed mail can be done by obtaining more accurate address information for employees for whom mail is being sorted and providing such information to senders. This solution is addressed by the system in method of the present invention.

Thus, one of the problems of the prior art is that a system is not available for to provide a closed loop solution for processing mail and improving data inaccuracies. Therefore, a system and method for processing mailpieces is needed which integrates mailpiece processing with the incoming mailpiece sorting apparatus and updates the sender data for improving accuracy of sender's addressee data for future mailings.

### SUMMARY OF THE INVENTION

This invention overcomes the disadvantages of the prior art by providing a method of processing incorrectly addressed mailpieces and providing updated data to sender(s) for preparation of future mailpieces. This in turn helps to solve data quality problems at their source and reduce processing costs by reducing the number of subsequent incorrectly addressed mailpieces. The present invention is directed to; in general, automated mail sorting and more particularly, a method of reducing incorrectly addressed incoming mail using a system including an automated mailpiece sorting apparatus.

An embodiment of the system of the present invention comprises a mailpiece sorting apparatus, a label printer, a monitor and graphical user interface, addressee database and obsolete address database. The system provides a closed loop solution for reducing future incorrectly addressed incoming mailpieces prepared by a sender external to the company sorting mailpieces using the incoming mailpiece sorting apparatus, although the system could also be used to notify internal senders.

An alternate embodiment of the system of the present invention includes a web server for interconnecting several components of the system sender computer system with sender database. The system could also be connected to a postcard printer and/or a sender electronic database.

In embodiment of the present invention, the system recognizes an incoming mailpiece as addressed to a former employee or an employee whose address has changed, the OCR system extracts the return or sender address from the mailpiece as well as the addressee address. The system prints a postcard or other suitable form, addressed to the return or sender address on the mailpiece, stating that the addressee is no longer at the current address. The system provides a corrected or forwarding address and provides a message stating, for example, that future mail should not be sent to the addressee.

A list of employees that no longer work at the company or a list of changed employee addresses can be used, as well as a database of forwarding addresses. Such information could be obtained from human resources or mailroom personnel. The incoming mail sorting apparatus can obtain a digital image of the front of an incoming mailpiece. After the digital image is obtained, an OCR system can determine that the mailpiece is addressed to a former employee or an employee whose address has changed, the return address in the upper-left-hand-corner of the mailpiece is extracted from the digital image and printed as the recipient address on a post card. The original recipient address is printed along with a forwarding address (if available). A message is sent to the addressor that, for example, the employee is no longer at the original recipient address. The original sender is instructed to update his or her database. In another example, if a forwarding address is not known for the intended recipient, the original sender is notified that the addressee has moved and a new address is not known and a request is made for the addressee to update his or her database.

A software control program implements the functionality of the present invention. The control program interfaces with the OCR system to recognize a recipient or addressee name as a former employee and notify the control processor and send the processor the recipient name. The control processor sends a message to the scanner to retrieve the two sub-images of the mailpiece containing the recipient address and the return sender's address. The control program queries the database for a forwarding address for the recipient name. The control program sends a message to a printer to print a post card addressed to the sender and a message and forwarding address stating that the recipient is no longer at this address.

An advantage of the present invention is that it provides a document management solution by providing a system and method to update the incoming mailpiece address stream. Another advantage of the present invention is that it reduces end-to-end costs, increases user convenience and improves delivery and reliability. Other advantages will in part be obvious and will in part be apparent from the specification. The aforementioned advantages are illustrative of the advantages of the various embodiments of the present invention.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is a block diagram that illustrates a computer system with which an embodiment of the invention may be implemented;

FIG. 2a illustrates the connection of the computer system to a sorting apparatus;

FIG. 2b is a block diagram illustrating an eight bin module which may be the mailpiece sorting apparatus which is used to perform an embodiment of the of the present invention;

FIGS. 3a-3d illustrate various reject mailpieces;

FIG. 4 is an exemplary mailpice with an incorrect addressee address.

FIGS. 5a-b illustrates a mailpiece for notifying the sender of the mailpiece of FIG. 4 of the new address for the addressee of FIG. 4.

FIGS. 6a-b illustrates a mailpiece for notifying the sender of the mailpiece of that a new address is not available for the addressee of FIG. 4.

FIG. 7 is a block diagram schematic of an embodiment of the apparatus present invention; and

FIG. 8 is a flowchart of an embodiment of the method of the present on for processing address updates.

### DETAILED DESCRIPTION OF THE PRESENT INVENTION

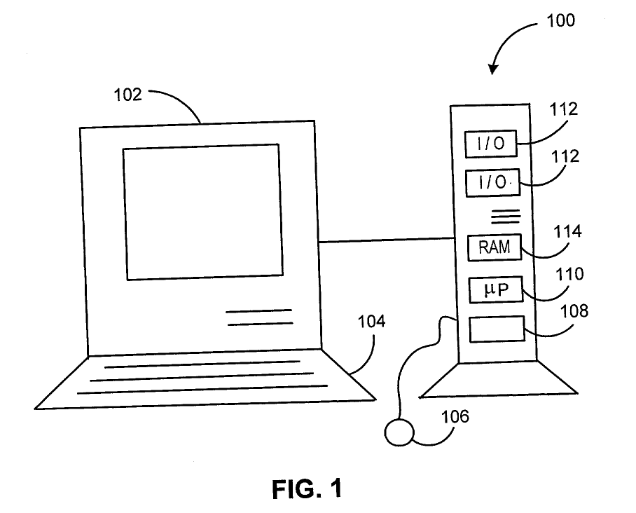

In describing the present invention, reference will be made herein to FIGS. 1-8 of the drawings in which like numerals refer to like features of the invention. Features of the invention are not necessarily shown to scale in the drawings.

Control and Mail Sorting Apparatus Overview

FIG. 1 is a block diagram that illustrates a computer system 100, the use of which an embodiment of the invention may be implemented. Computer system 100 may be a personal computer which is used generically and refers to present and future microprocessing systems with at least one processor operatively coupled to user interface means, such as a monitor 102 and keyboard 104, and/or a cursor control, such as a mouse or a trackball 106, and storage media 108. The personal computer 100 may be a workstation that is accessible by more than one user. The personal computer also includes a conventional processor 110, such as a Pentium® microprocessor manufactured by Intel, and conventional memory devices such as hard drive 108, floppy or CDRW drive(s) 112, and memory 114.

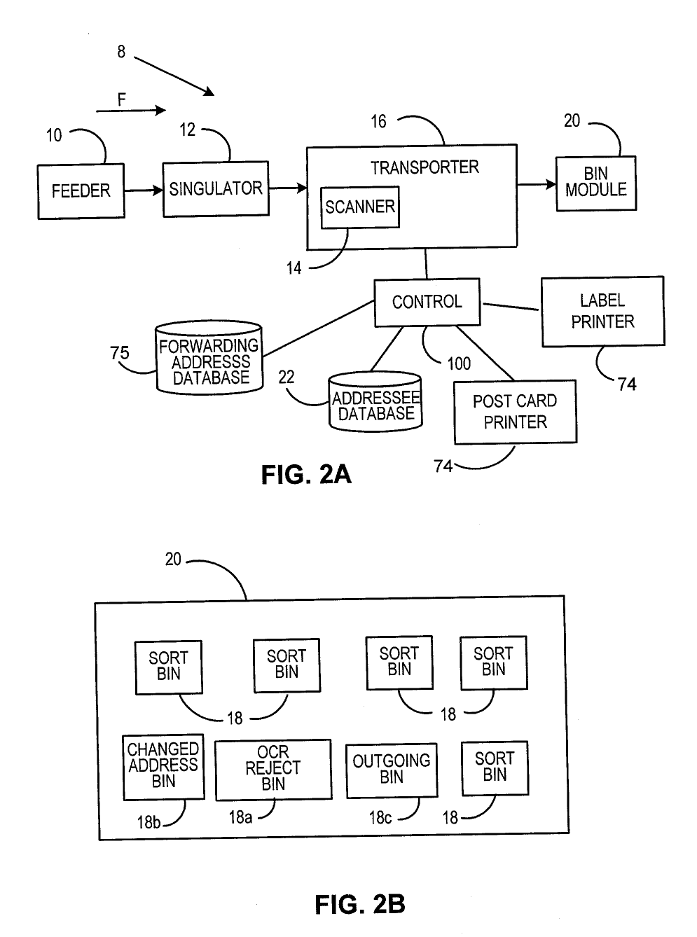

The computer system 100 can be connected to a sorting apparatus 8 as illustrated in FIG. 2a. The mailpiece sorting apparatus 8 may generally comprise a feeder 10, a line scan camera 14 (and optical character recognition (OCR) software, not shown), a video scanner 15, a mailpiece transporter 16, a bin module 20 (shown in FIG. 2b) with compartments or bins 18 (sort bin), 18a (OCR reject bin), 18b (RTS bin), 18c (outgoing bin) for receiving sorted mailpieces 30 and a control system 24 which may be the microprocessor based personal computer system 100 described above. The computer system 100 includes appropriate memory devices 108, 114 for storage of information such as an address database 22. One of ordinary skill in the art would be familiar with the general components of the sorting apparatus with which the system and method of the present invention may be implemented.

The mailpiece sorting apparatus 8 and the OCR software may be used to determine the addressee of the mailpiece 30 or other information such as return to sender graphics printed on the face of the mailpiece 30. The reading of various information may be performed with the assistance of intelligent character recognition (ICR) or imaging and optical character recognition (OCR/IC), which may be part of the above-mentioned OCR software and can read the various fields on the mailpiece 30.

Reject Mailpieces

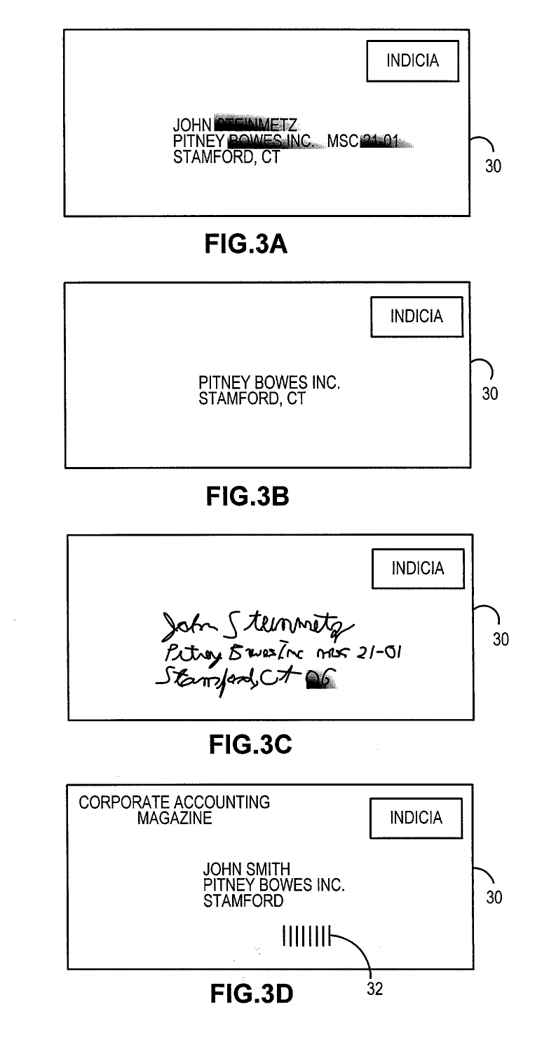

FIGS. 3a-3d illustrate various reject mailpieces 30. FIG. 3a is an example of a reject mailpiece 30, which is unreadable by the OCR system of the mailpiece sorting apparatus 8 because the addressee information is smeared (OCR reject). In some instances, the addressee information can be smeared to the point where the operator would need to open the mailpiece 30 to determine the addressee. FIG. 3b is an example of a reject mailpiece 30 for which the intended individual addressee cannot be determined from the face of the mailpiece 30 because there is no individual addressee but rather a general address to the company, as in this example, Pitney Bowes Inc. (mystery mail). In the case of the mystery mail of FIG. 3b, the mailpiece 30 would need to be opened to determine the appropriate addressee. In another example, not shown, the mailpiece 30 could be addressed to a company and/or department and would need to be opened to determine the appropriate addressee.

FIG. 3c is an example of mystery mail for which the intended individual addressee cannot be determined using OCR because the handwriting in the addressee segment is unreadable by the OCR of the mailpiece sorting apparatus 8 (mystery mail). It should be noted that while some handwriting is readable by OCR systems, not all handwriting is automatically readable, especially handwriting where the character shapes are of poor quality and are poorly spaced such as, for example, some cursive writing as is illustrated on mailpiece 30 in FIG. 3c.

FIG. 3d is an example of a reject mailpiece 30 for which the operator can determine the appropriate addressee from the face of the mailpiece 30 (without opening the mailpiece 30) but for which the OCR system of the mailpiece sorting apparatus 8 could not determine the appropriate addressee (research mail). In the example of FIG. 3d, the addressee database 22 contains two addressees named John Smith. The operator may be able to determine the appropriate addressee by reading the return address information. For example John Smith in accounting might get a mailpiece with a return address of a corporate accounting magazine, whereas John Smith of legal might get a mailpiece with a return address of a corporate counsel society. Thus, the mailpiece of FIG. 3d would be routed to John Smith of accounting and such information would be input by the operator using the voice recognition system.

Incorrect Address Mailpiece & Sender Update Postcard

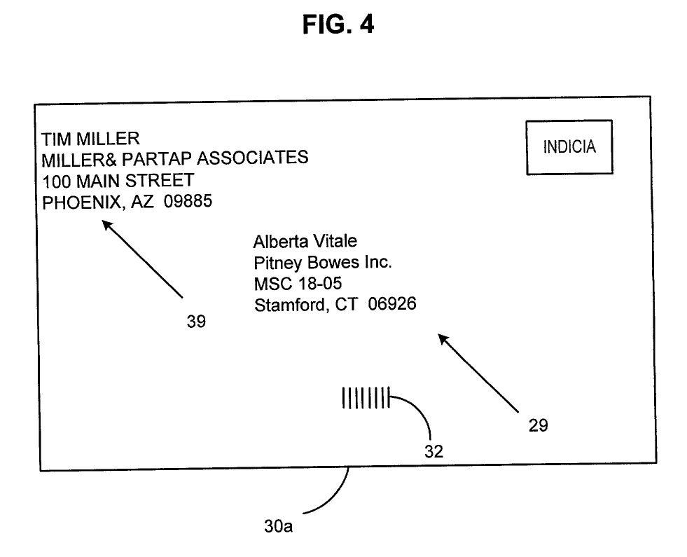

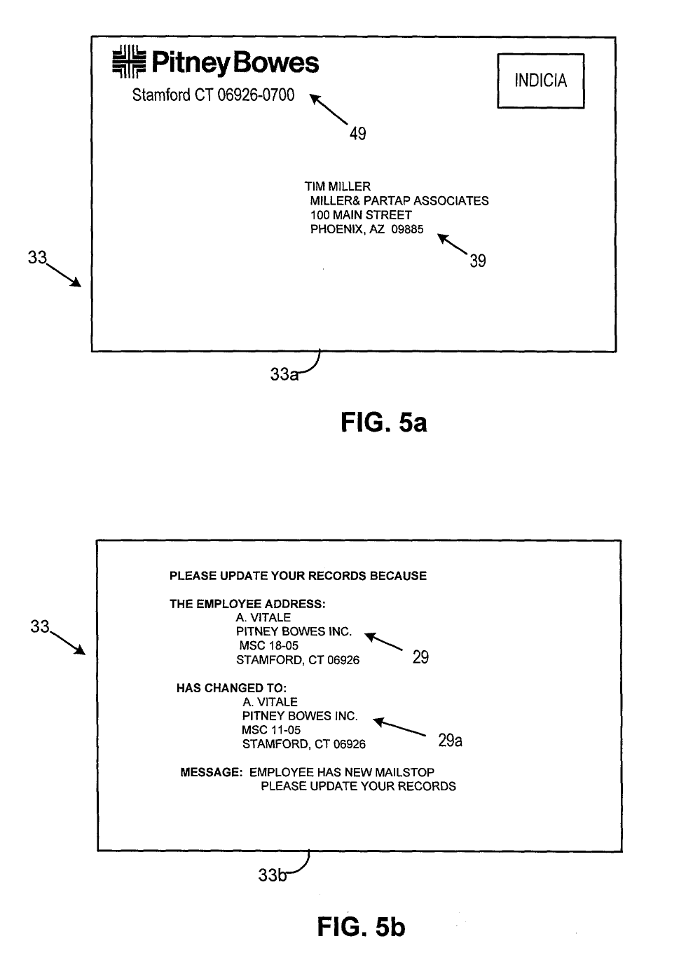

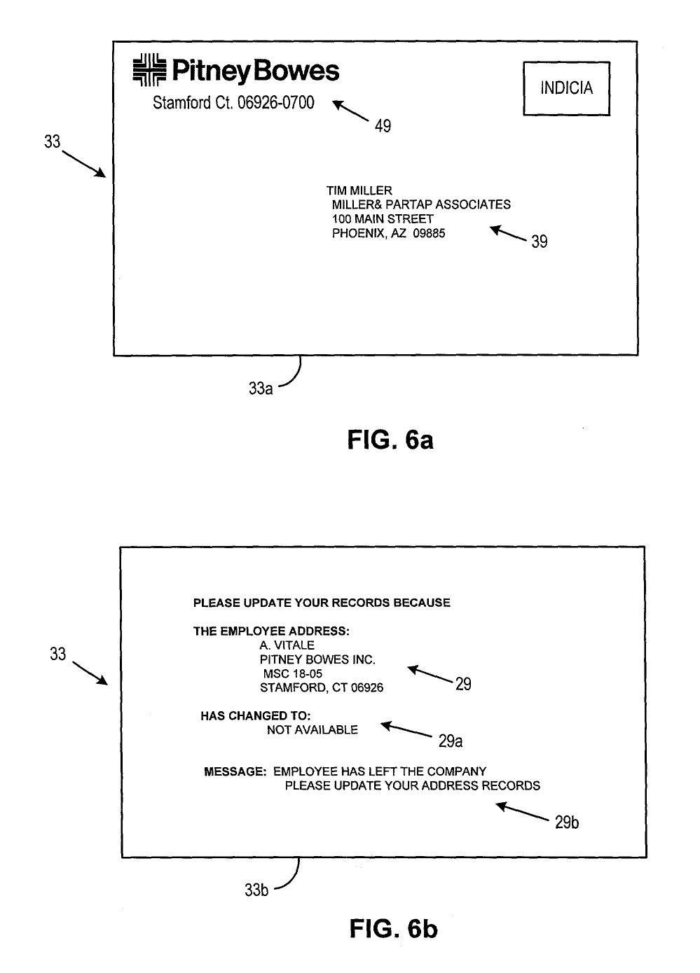

FIG. 4 is an exemplary mailpiece 30a with an incorrect address for the addressee 29 of mailpiece 30a. Incorrectly addressed mailpieces 30a, like the reject mailpieces 30 described above, need additional processing and are more expensive to processing. FIGS. 5a-b are illustrations of the front (33a) and back (33b) sides of a postcard 33 for notifying the sender 39 of mailpiece 30a of FIG. 4 of a new or forwarding address 29a for the addressee 29 (in this example, the employee's mailstop changed). A message 29b is indicates that the employee (from addressee information 29) has a new mailstop and requests update of sender's 39 records. Other suitable messages can be printed on postcard 33. FIGS. 6a-b are illustrations of the front (33a) and back (33b) sides of a postcard 33 for notifying the sender 39 of mailpiece 30a of FIG. 4 of an unavailable forwarding address 29a and a message 29b stating that the addressee has left the company. The method and apparatus of the present invention provide the ability to read the mailpiece 30a of FIG. 4 and produce the postcard 33. The return address of FIGS. 5a and 6a is the addressee's employer's address 49; however, any suitable address can be used as determined by the needs of the company. A message 29b is indicates that the employee (from addressee information 29) has left the company and requests update of sender's 39 records.

System for Notifying Sender of Address Change for Addressee

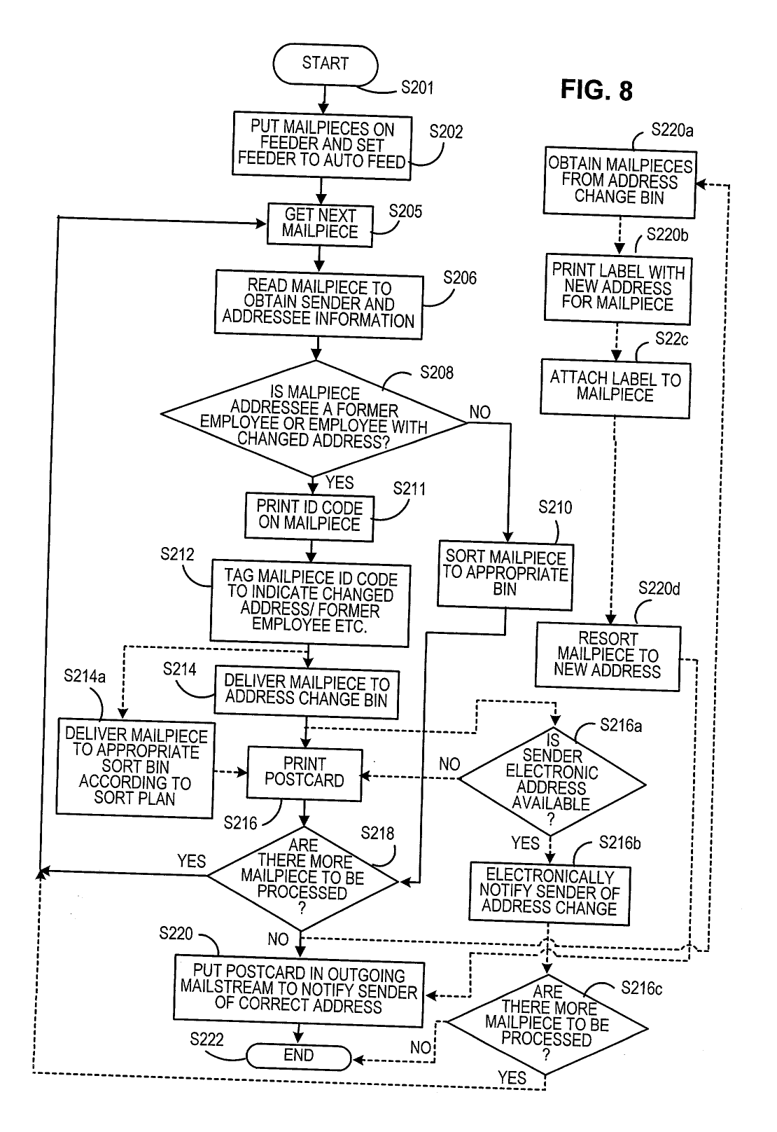

An embodiment of the system of the present invention is illustrated in FIG. 8 and referred to generally as system 200, which comprises mailpiece sorting apparatus 8, addressee database 22, obsolete address database 75, and postcard printer 74a. The mail sorting apparatus 8, as described above, reads the addressee and sender information using the OCR system 14 and provides the sender 85 with updated addressee information. The system 200 provides a closed loop solution for reducing incorrectly addressed incoming mailpieces 30 generated by the sender 85 outside the company. The company is sorting incoming mailpieces with the automated mailpiece sorting apparatus 8.

In the alternate embodiment the system comprises a web server 80 for facilitating the transmission of addressee information to the sender 85 so that sender can update sender records such as for example, sender's addressee database 85a. Transmission by other means could be determined by one of ordinary skill in the art. Alternately, the system 200 can also include a label printer 74 for labeling the mailpiece with updated addressee information. In another embodiment the system can include sender electronic addresses so that the sender can be sent updated addressee information electronically.

Method for Notifying Sender of Address Change for Addressee

FIG. 9 illustrates an embodiment of the method of the present invention for notifying sender of address change for addressee. An embodiment of a method of the present invention may be performed using the system 200 (illustrated in FIG. 8). Turning to FIG. 8, at step S201 the method begins. At step S202 a stack of incoming mailpieces (not shown) is placed on the feeder 10 of the mailpiece sorting apparatus 8 and the feeder 10 is set to auto feed and mailpieces 30 begin to be fed along feed path F of the mailpiece sorting apparatus 8. At step S205 a mailpiece 30 is separated from the stack. At step S206 the mailpiece 30 is read using the OCR system and sender information is stored in memory until later determination is made as to whether sender information is needed (i.e. at step 208 where the mailpiece is determined to be incorrectly addressed). Next at step S208 a query is made as to whether the mailpiece 30 is addressed to a former employee or an employee with a changed address. This step is performed using comparison software (not shown) and obsolete address database 75. The obsolete address database 75 contains obsolete address information for employees who have moved or left the company or had an address change for other reasons. The obsolete information corresponds to current addressee information in the addressee database 22. Alternately, the obsolete and current addressee information could be stored in a single database.

If the answer to the query of step S208 is no, then the mailpiece 30 is delivered to an appropriate sort bin 18 at step S210. The determination as to which bin the mailpiece 30 should be sorted to is made using a sort plan, which assigns addressees to particular bins. The determination of addressee information for mailpieces other than the mailpiece 30 that is addressed to a former employee or an employee with a changed address will not be discussed in the present invention except to note that one of ordinary skill in the art could perform such process.

Returning to the query of step S208, if the answer to the query S208 is yes, then at step S211 a mailpiece ID code 32 is printed on the mailpiece and stored in the mailpiece sorting apparatus 8 in association with other information about mailpiece 30a. Next at step S212 the mailpiece 30a (shown in FIG. 4) ID code 32 is tagged to indicate information such as obsolete address, former employee and updated address information at step S212. Next at step S214, the mailpiece 30a is delivered to changed address bin 18b. In an alternate embodiment (indicated by a dashed line connecting step S214a to the flowchart, instead of delivering the mailpiece 30 to address change bin 18b, the mailpiece 30 is delivered to an appropriate sort bin 18. The appropriate sort bin 18 is determined using current address information from addressee database 22 and the sort plan (discussed above).

Step S214 (or alternately step S214a shown with dashed connecting lines) is followed by step S216 where a postcard is printed using postcard printer 74a. Exemplary postcards are illustrated in FIGS. 5a-b and 6a-b. In each example, the postcard corresponds to the incorrectly addressed incoming mailpiece illustrated in FIG. 4. In the example of FIG. 5 the front side 33a of postcard 33 is printed with the sender address (from incoming mailpiece 30a of FIG. 4) in the addressee portion of the postcard. The backside 33b of the postcard 33 is printed with the obsolete employee address (obtained from incoming mailpiece 30a of FIG. 4) and new address obtained from addressee database 22. Additionally a message can be printed on the postcard, such as, for example in FIG. 5, the message indicates that the employee has a new mailstop and requests the sender to please update records. Such information can be appended to the information in the addressee database 22 in association with the addressee records.

In the example of FIG. 6 the front side 33a of postcard 33 is printed with the sender address 39 (from incoming mailpiece 30a of FIG. 4) in the standard addressee portion of the postcard. The backside 33b of the postcard 33 is printed with the obsolete employee address 29 (obtained from incoming mailpiece 30a of FIG. 4). In this example, no new address is available. The message 29b indicates that the employee has left the company and requests the sender 39 to update his or her address records. Again, such message information can be appended to the information in the addressee database 22 in association with the addressee records. In this example, the addressee records of database 22 may contain an instruction to sort the mailpiece to reject bin 18a since an appropriate address cannot be determined.

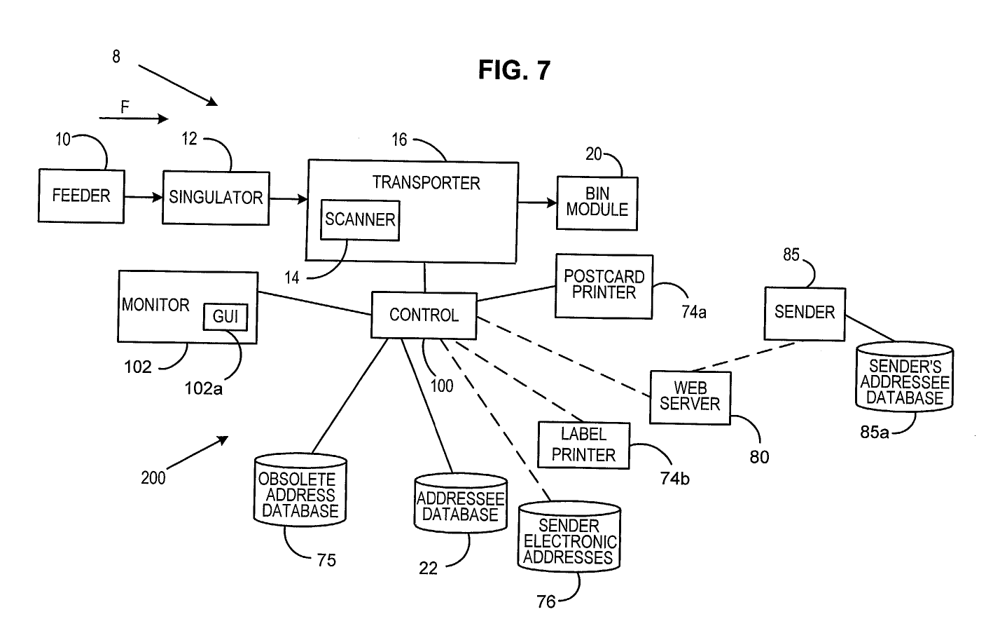

Following step S216 a query is made at step S218 as to whether there are additional mailpieces 30 to be processed. If the answer to the query of step S218 is yes, then steps S205 through S216 are performed until no mailpieces 30 are left to be processed. If the answer to the query of step S218 is no, then the method proceeds to step S220 where postcards 33 are placed into outgoing mailstream for delivery to sender. In an alternate embodiment (indicated by a dashed line connecting steps S216a-S216c), instead of or in addition to performing step S216 (printing postcard) alternate steps are performed. In the alternate embodiment, a query is made at step S216a as to whether the sender electronic address is available in database 76 of system 200 (shown in FIG. 7). If the answer to the query of step S216a is no, then the method continues to step S216 and a postcard is printed (as described above). Next at step S218 a query is made as to whether there are more mailpieces 30 to be processed. If the answer to the query of step S218 is yes, then steps S205 through S216 are performed until no mailpieces 30 are left to be processed. If the answer to the query of step S218 is no, then the method proceeds to step S220 where postcards 33 are placed into outgoing mailstream for delivery to sender

Returning to the query of alternate step S216a, if the answer to the query of step S216a is yes, then the sender is notified of the updated addressee information via electronic message at step S216b. Next at step S216c a query is made as to whether there are more mailpieces 30 to be processed. If the answer to the query of step S216c is yes, then the method repeats from steps S205 through S220 as appropriate. Following the step S220, or following step S216c where the answer to the query is no, the method ends at step S222.

In an alternate embodiment of the present invention (shown with dashed lines connecting steps S220a-S220d), if the answer to the query of step S218 is no, then at step S220a mailpieces are obtained from changed address bin 18b. A label is printed using the updated address for the mailpiece at step S220b. Next at step S220c the label is attached to the mailpiece 30a and at step S220d the mailpiece is resorted using the mailpiece sorting apparatus and the information tagged to the ID code. The label is printed and adhered to the mailpiece 30a so that manual delivery of the mailpiece can be performed (by reading the addressee label on the mailpiece) after automated sorting or instead of automated sorting of step S220d.

The label information, instead of being obtained from the mailpiece sorting apparatus (where it was read in step S206 of the method) could be input by an operator using a graphical user interface. The operator could use, for example, the computer system 100 of the mailpiece sorting apparatus 8, which has monitor 102 (which can display the graphical user interface 102a (GUI) to provide the operator with a helpful interface to request functions such as create a new mailing label or input address information). The label printed at step S220b can be printed using label printer 74 of system 200, which may be a type of commercially available printer, connected in serial or parallel communication with the microprocessor 110 for control thereby.

By the method of the present invention, the sender 39 can be notified of the correct address 29a or notification of an incorrect address, as the case may be, is sent to the sender 85 of the mailpiece 30a (preferably via email although other suitable methods may be used) and/or to the sender's database 85a for action such as correction, notation or deletion of the address record. This is done to prevent future mailings to the same addressee and thus reduce future incorrectly addressed incoming mailpieces 30a generated by the sender.

The system 200 of the present invention helps to reduce the volume of mail with incorrect addressee addresses and lower mail processing costs. It also helps to maximize mail deliverability, reduce costs associated with paper, envelopes, printing, postage and labor. It can also help to increase efficiency and productivity in mailing operations. The system 200 as implemented in the present invention can help a company reduce the amount of incorrectly addressed mailpieces that are created in by a sender by providing updated addressee information for future sender mailings.

The embodiments described herein can provide the advantages of lowering the costs of processing mailpieces by creating a system with the capability of conveying information regarding incorrectly addressed mailpieces so that such information can be used in future incoming mailpiece processing and future outgoing mailpiece processing created by a sender (such as updating senders databases and informing senders of changed addresses). By implementing the present invention, companies handling very large numbers of incoming mailpieces can save thousands of dollars per year. While the present invention has been disclosed and described with reference to a various embodiments thereof, it will be apparent, as noted above that variations and modifications may be made therein. It is, thus, intended in the following claims to cover each variation and modification that falls within the true spirit and scope of the present invention.

What is claimed is:

1. A method of cleansing an incoming mailstream using an incoming mail sorting apparatus having a database of addressees for use in sorting incoming mailpieces comprising the steps of:
a) collecting addressee information and sender information from a mailpiece;
b) identifying the addressee information as incorrect;
c) determining the senders address;
d) determining, if available, updated addressee information; and
e) informing the sender of the updated addressee information.

2. The method of step 1 whereby in step e), informing the sender of the updated addressee information is performed by sending a notification mailpiece to the sender including updated addressee information.

3. The method of step 1 further comprising the step of:
f) determining if a sender electronic mail address is available; and
g) informing the sender of the updated addressee information by sending an electronic mail message to the sender including updated addressee information.

4. The method as claimed in claim 1 further comprising the steps of:
f) printing a label with updated address information;
g) attaching the label to the mailpiece;
h) sorting the mailpiece using the incoming mail sorting apparatus; and
i) delivering the mailpiece to an appropriate sort bin.

5. The method as claimed in claim 4 further comprising the step of:
j) delivering the mailpiece to an addressee indicated on the label printed with the updated address information.

6. The method as claimed in claim 1 further comprising the step of:
f) delivering the mailpiece to an appropriate sort bin.

7. An system for sorting incoming mailpieces and processing address changes, the system comprising:
a mailpiece sorting apparatus for sorting incoming mailpieces and determining whether a mailpiece is incorrectly addressed by reading addressee information from the mailpiece and comparing the read information to correct addressee information stored in at least one addressee database; and
a printer operatively coupled to the mailpiece sorting apparatus, the printer for printing a notification mailpiece with addressee information obtained from the at least one addressee database, the postcard for notifying the sender of the mailpiece that the addressee information is incorrect.

8. The system as claimed in claim 7 whereby the printer also prints updated addressee information on the notification mailpiece.

9. The system as claimed in claim 7 whereby the printer also prints a message on the notification mailpiece.

10. The system as claimed in claim 7 further comprising:
a label printer operatively coupled to the mailpiece sorting apparatus, the label printer for printing a label with addressee information obtained from the at least one addressee database, the label for placing on the incoming mailpiece to assist in subsequent delivery of the mailpiece to an addressee printed in the addressee information on the label.

11. A system for sorting incoming mailpieces and processing address changes comprising:
a mailpiece sorting apparatus for sorting incoming mailpieces and determining whether a mailpiece is incorrectly addressed by reading addressee information from the mailpiece and comparing the read information to correct addressee information stored in at least one addressee database; and
a sender's addressee database operatively coupled to the mailpiece sorting apparatus, the sender addressee database for receiving updated addressee information, whereby a sender can use the updated addressee information on subsequent mailpieces sent to the addressee.

12. The system as claimed in claim 11 whereby the mailpiece sorting apparatus further comprises a sender's electronic address database and the system sends the sender updated addressee information to the sender's electronic mail address obtained from the sender's electronic address database.

13. The system as claimed in claim 10 further comprising:
a graphical user interface displayed operatively coupled to the mailpiece sorting apparatus, the graphical user interface comprising an input field, for inputting information for printing on the label.

14. A method of sorting incoming mailpieces using an incoming mailpiece sorting apparatus, the method comprising the steps of:
a) collecting addressee information and sender information from a mailpiece;
b) identifying the addressee information as incorrect;
c) determining the senders address;
d) determining, if available, updated addressee information;
e) notifying the sender of the updated addressee information.
f) printing a label with updated address information;
g) attaching the label to the mailpiece;
h) sorting the mailpiece using the incoming mail sorting apparatus; and
i) delivering the mailpiece to an appropriate sort bin.

15. The method as claimed in claim 14 further comprising the step of:
j) delivering the mailpiece to an addressee indicated on the label printed with the updated address information.
